(19) United States
(12) Patent Application Publication
(10) Pub. No.: US 2017/0210284 A1
(43) Pub. Date: Jul. 27, 2017

(54) VEHICLE-MOUNTED RETRACTABLE ILLUMINATED EMERGENCY ALERT SYSTEM

(71) Applicant: William Donan, Louisville, KY (US)

(72) Inventor: William Donan, Louisville, KY (US)

(21) Appl. No.: 15/003,293

(22) Filed: Jan. 21, 2016

(51) Int. Cl. B60Q 1/46

(52) U.S. Cl. CPC B60Q 1/46

(57) ABSTRACT

The present invention provides an alert mechanism for directing non-responding traffic away from a responding vehicle and personnel. A first member is fixed to a vehicle and a second elongated member is movably attached to the first member. A deployment mechanism permits movement of the second elongated member relative to the first member from a retracted position to a deployed position. A set of alert indicators are affixed to the second elongated member and comprise illuminating elements to give visual indication on deployment. An actuator electromechanically moves the second elongated member from a retracted position to a deployed position and back. The invention may be used to alert approaching traffic to traffic stop situations and to presence of emergency vehicles and personnel in times of emergency.

### FIELD OF THE INVENTION

The present invention relates generally to the field of law enforcement, first responder situations including fire and rescue and recovery operations and in particular to the use of an emergency alert mechanism to warn and divert traffic to facilitate safety of law enforcement, fire, ambulance and other first responders.

### BACKGROUND OF THE INVENTION

Law enforcement personnel as well as fire and other responders are often placed in hazardous locations and situations. For instance, when police officers pull over drivers for speeding or other violations they must exit their police cruiser or vehicle. While questioning drivers and issuing citations police officers are exposed to traffic, in particular to cars approaching from behind the police vehicle. Safety becomes increasingly an issue at night time and/or in rainy, foggy or other poor weather conditions. In addition, fire and rescue and ambulance personnel are often placed in hazardous conditions due to the nature of their job and the need to respond in emergency situations to persons in need of help.

Law enforcement and many emergency vehicles are outfitted with alert devices such as flashing lights. These alert devices come in many forms and configurations, however a problem is that the alert devices used today with few exceptions conform to the contour of the vehicle and do not provide a direct means for diverting traffic away from officers and emergency personnel responding to intended situations normally encountered in performance of their duties.

In the United States over 160 law enforcement officers have been struck and killed by motorist who fail to change lanes or otherwise provide clearance of officers discharging their duty during a traffic stop. Changing lanes or “moving over” is mandated by law in forty-three states in the U.S. and is just good practice for safety reasons.

What is needed is a solution to address the various problems associated with unsafe conditions for officers and others outside police and other vehicles and the deficiencies of existing vehicle-mounted alert devices.

What is needed is a way to alert approaching drivers' to stopped law enforcement and emergency vehicles so as to direct them away from the vehicles and personnel operating outside such vehicles.

### SUMMARY OF THE INVENTION

The present invention solves problems related to safety of law enforcement and emergency personnel when responding to situations that place them in harm's way. Law enforcement and many emergency vehicles are outfitted with alert devices such as flashing lights in many forms and configurations, all of which fit the contour of their vehicle and do not effectively extend away from the vehicle and the personnel outside of the vehicle. The invention provides a swing away light bar that can be mounted on the lower cowl (bumper) below the trunk. It would be operated at the operator's discretion by an electric motor and would swing 180 degrees out and away from the side of the vehicle, allowing a signaled protective envelope for officers and first responders to exit their vehicle. The LED light system may for instance take the form of an arrow to “point” or direct approaching vehicles to move away from a stationary vehicle, e.g., a law enforcement, emergency, ambulance, construction, delivery or other vehicle, like a mobile, deployable highway or road sign. Preferably the arm extends so as to create a safety zone alongside the attached vehicle.

With the lighting system mounted to the cowl, the light bar would be secured by the mounting and by a bracket, e.g., like an SUV rear window wiper. When activated it would swing 180 degrees with the LED flashing directionally for the length of the mount as well as the “arm.” Both sides of the “arm” or elongated member may be lighted or illuminated, such as with LEDs or other flashing lights or display panels, so the responder vehicle would be lighted in both directions. The illuminated extended arm would signal approaching vehicles that the responder is stopped and they should move over or slow down. In one manner of operation the device would operate by an electric motor with “stops” at 0 degrees and 180 degrees. The mounting bracket could consist of a plastic mount the length of the folded LED bar as well as a bracket to support the bar when not in use. The mounting bracket would support the electric motor and LED bar. Application would be for all police and first responders (fire, ambulance, wreckers, tow trucks, etc.) as well as other governmental or civilian vehicles, e.g., concrete or other delivery trucks and construction vehicles. It could also be used on heavy equipment or articulated machinery to avoid a pinch zone.

### BRIEF DESCRIPTION OF DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 represents a schematic diagram of a first embodiment of the retractable emergency alert mechanism of the present invention as shown in a retracted state.

FIG. 2 is a schematic diagram representing the first embodiment of the retractable emergency alert mechanism in a deployed configuration.

FIG. 3 is a schematic diagram representing an alternative configuration of the retractable emergency alert mechanism in a deployed state.

FIGS. 4A and 4B represent top views of the retractable emergency alert mechanism mounted to an exemplary emergency vehicle as shown respectively in retracted and deployed states in accordance with the invention.

FIGS. 5A and 5B represent top views of the retractable emergency alert mechanism mounted to an exemplary law enforcement vehicle as shown respectively in retracted and deployed states in accordance with the invention.

FIG. 6 is a side view of the retractable emergency alert mechanism mounted to a rear end of the exemplary law enforcement vehicle of FIGS. 5A and 5B.

FIGS. 7A and 7B are rear views of the retractable emergency alert mechanism mounted to a rear end of the exemplary law enforcement vehicle of FIGS. 5A and 5B as shown respectively in retracted and deployed states in accordance with the invention.

FIG. 8 is a front view of the retractable emergency alert mechanism mounted to a rear end of the exemplary law enforcement vehicle of FIGS. 5A and 5B as shown in a deployed state in accordance with the invention.

FIG. 9 is a schematic diagram representing a further alternative configuration of the retractable emergency alert mechanism shown in a retracted state.

FIG. 10 is a schematic diagram representing the alternative retractable emergency alert mechanism of FIG. 9 in a deployed state.

FIGS. 11A and 11B are rear views of the alternative retractable emergency alert mechanism of FIG. 9 mounted to a rear end of an exemplary law enforcement vehicle as shown respectively in retracted and deployed states in accordance with the invention.

### DETAILED DESCRIPTION OF PREFERRED EMBODIMENT

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The present invention provides a retractable alert mechanism for directing non-responding traffic away from a responding vehicle, such as a police vehicle or emergency vehicle, and personnel, such as police officers, firemen and emergency responders. The alert mechanism includes a first member or anchor adapted to be attached to a rear portion of the vehicle by way of a hinged or other pivot mechanism. A second, elongated member is movably attached to the first member or anchor and the pivot or sliding mechanism. A deployment mechanism operably connected to the first member and the second elongated member permits movement of the second elongated member relative to the first member from a retracted position to a deployed position. Alert indicators are attached to the second elongated member and optionally the first member as well and may include bright and/or flashing illuminating elements, such as LEDs (light emitting diodes or devices) to give visual indication when the second elongated member is deployed. An actuator electromechanically moves the second elongated member from a retracted position to a deployed position and from a deployed position to a retracted position. In the deployed position with the police or emergency vehicle stopped along a vehicle roadway or at the site of an emergency, the occupant of the vehicle may deploy the second elongated member causing it to extend outwardly away from the vehicle. Deploying the second member may automatically illuminate the alert indicators to provide illumination in a rearward direction toward approaching traffic to direct traffic away from the vehicle.

The deployment mechanism may be a pivot or a hinge mechanism, e.g., strap hinge, allowing the second elongated member to pivot or rotate outward from the rear of the vehicle when actuated from a retracted position to a deployed position. An internal stop may be integral with the actuator/hinge assembly to limit the movement of the diverting arm to a rotation of 180 degrees. The deployment mechanism may include an internal gear drive and pivot pin assembly and a 12 volt motor commonly available. A wide variety of mechanism. Alternatively, the deployment mechanism may be a sliding mechanism allowing the second elongated member to slide outward from the rear of the police vehicle and away from the first member when actuated from a retracted position to a deployed position.

The alert mechanism may include a camera positioned to capture video of approaching traffic when the second elongated member is in the deployed position. The alert mechanism may include a proximity sensing device adapted to sense a proximity of an approaching vehicle to the police vehicle and to activate a high intensity alert indicator directed to the approaching vehicle. The proximity sensing device may be adapted to sense a proximity of an approaching vehicle to the police vehicle and to activate an alert indication to the officer operating the police vehicle. The set of alert indicators may be one or more of a light emitting device (“LED”), an illuminated text message, a flashing directional arrow representation, and a series of lights illuminating in a repeating sequence. The actuator may be an electromechanical device electrically controlled by a control device located in the interior of the police vehicle.

In an alternative embodiment, the present invention provides a retractable alert mechanism for use with a responding vehicle for alerting of emergency situations. The alert mechanism includes an anchor fixably attached to a rear portion of an emergency vehicle by any suitable means, including brackets, nut/bolt pairs, chemical bonding, adhesive compound, and welding. An elongated member is movably attached to the anchor and the pivot or sliding mechanism. A deployment mechanism operably connected to the anchor and the elongated member permits movement of the elongated member relative to the anchor from a retracted position to a deployed position. In the deployed position with the emergency vehicle stopped along a vehicle roadway or at the site of an emergency, the occupant of the vehicle may deploy the elongated member causing it to extend outwardly away from the vehicle. Deploying the second member may automatically illuminate the alert indicators to provide illumination in a rearward direction toward approaching traffic to direct traffic away from the vehicle.

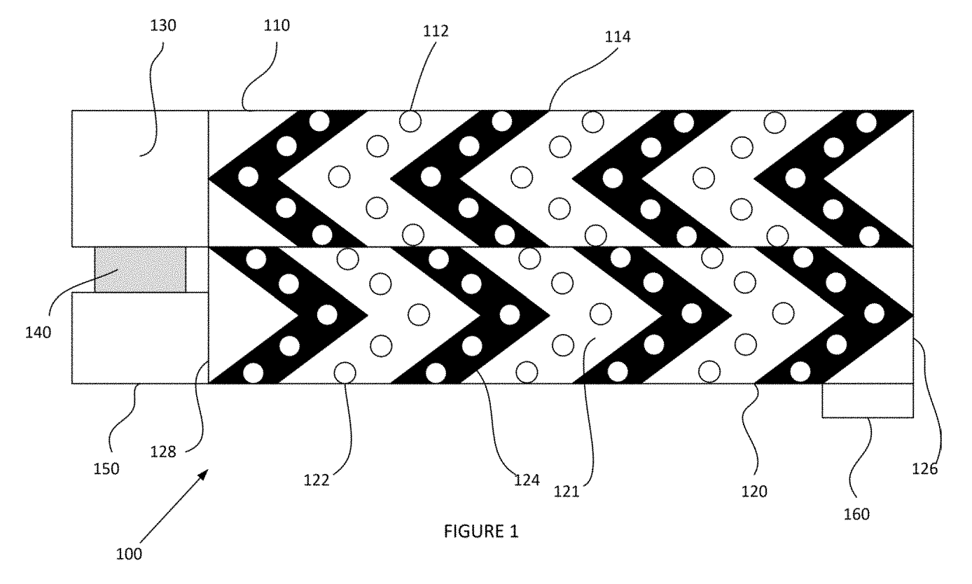

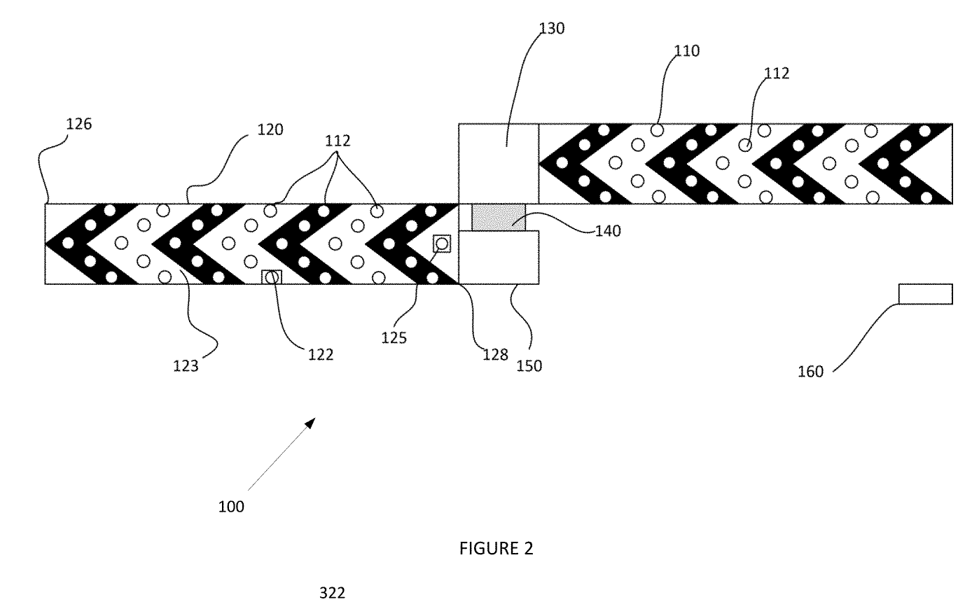

With reference now to FIG. 1, a schematic diagram of a retractable emergency alert mechanism 100 is shown in a retracted state. FIG. 2 illustrates the retractable emergency alert mechanism 100 in a fully deployed position 180 degrees open. Alert mechanism 100 includes a first member or anchor 110, shown as an elongated member, adapted to be attached to a rear portion of a vehicle (not shown), such as a police vehicle or emergency response vehicle. A hinge 140 or other pivot mechanism connects the first member 110 or anchor to a second, elongated member 120 respectively at pivot junctures. The second member 120 rotates outwardly away from the vehicle 180 degrees to a fully deployed position with point 126 being most removed from the vehicle and point 128 being closest to the vehicle. Alternatively, instead of a hinge or pivot mechanism the first and second members 110,120 may be operably connected by way of a sliding mechanism, whereby the first member 110 is fixed relative to the vehicle and the second member 120 slides away from the vehicle and first member from a retracted to a deployed position when activated.

A deployment mechanism is shown in the form of components 130,140,150 and may be in the form of an actuator or electric motor operably connected to the first member and the second elongated member in the nature of a hinge or pivot or a sliding mechanism (shown in the drawing as a hinge/pivot configuration). Deployment components 130 and 150 are respectively shown connected to first member 110 and second member 120 and permits movement of the second elongated member relative to the first member from a retracted position (FIG. 1) to a deployed position (FIG. 2). An actuator electromechanically moves the second elongated member from a retracted position to a deployed position and from a deployed position to a retracted position. Preferably the alert mechanism is located on the rear of the vehicle at a location so that top 114 of the uppermost member, here first member 110, does not obscure the line of site of a driver operating the vehicle. Although shown in this exemplary embodiment with the fixed member 110 at the top of the alert mechanism, the rotating member 120 may be at the top of the mechanism. A stop or catch 160 provides a resting place for the second member 120 when in the retracted position to help hold the member in place and to protect against damage to the mechanism.

Further, although described herein and shown in examples as located on the rear of the vehicle, the alert mechanism may be disposed on the top of the rear deck lid preferably in a flat position with a means for rotating the alert mechanism up to a perpendicular standing position relative to the deck lid as part of the deployment process. Once in the raised upright position the second member may be rotated or slid out and away from the vehicle.

Alert indicators are attached to or form part of the second elongated member 120 and optionally the first member 110 as well and may include bright and/or flashing illuminating elements, such as LEDs (light emitting diodes or devices) 112 to give visual indication when the second elongated member is deployed. Flashing or reflective segments 121, 123, 124 may be in the shape of directional arrows, as shown, to direct approaching traffic away from the vehicle. In the deployed position with the police or emergency vehicle stopped along a vehicle roadway or at the site of an emergency, the occupant of the vehicle may deploy the second elongated member 120 causing it to extend outwardly away from the vehicle. Deploying the second member 120 may automatically illuminate the alert indicators to provide illumination in a rearward direction toward approaching traffic to direct traffic away from the vehicle.

The alert mechanism may optionally include a camera 122 positioned to capture video of approaching traffic when the second elongated member is in the deployed position. The alert mechanism 100 may include a proximity sensing device 125 adapted to sense a proximity of an approaching vehicle to the police vehicle and to activate a high intensity alert indicator directed to the approaching vehicle. The proximity sensing device 125 may be adapted to sense a proximity of an approaching vehicle to the police or responding vehicle and to activate an alert indication to the officer or responder operating the vehicle.

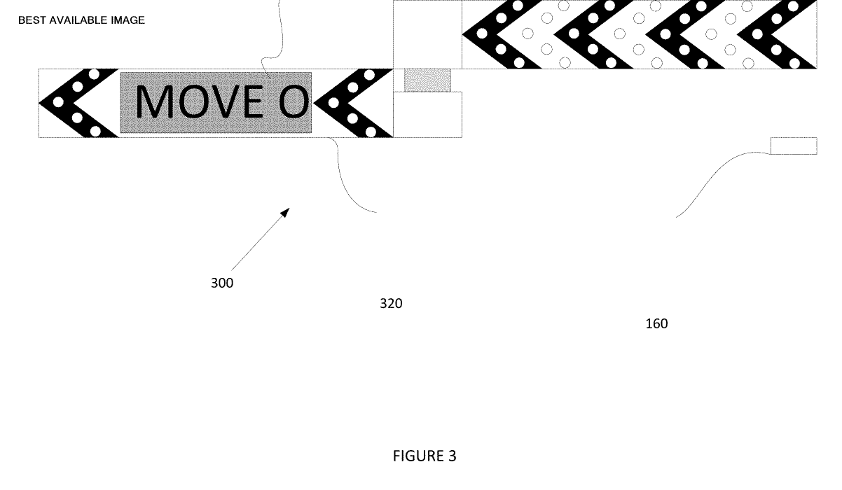

With reference to FIG. 3, a schematic diagram representing an alternative configuration retractable emergency alert mechanism 300 is shown in a deployed state. As shown, second member 320 includes a text display panel 322 in addition to a set of alert indicators. The panel may comprise an array of LEDs or other illuminating objects capable of presenting an illuminated text message. The message may be preprogrammed and incorporated into a control module having a memory and a processor and a human interface for programming and set-up purposes. The module may be adapted to automatically or selectively display selected text upon deployment of the second member 320.

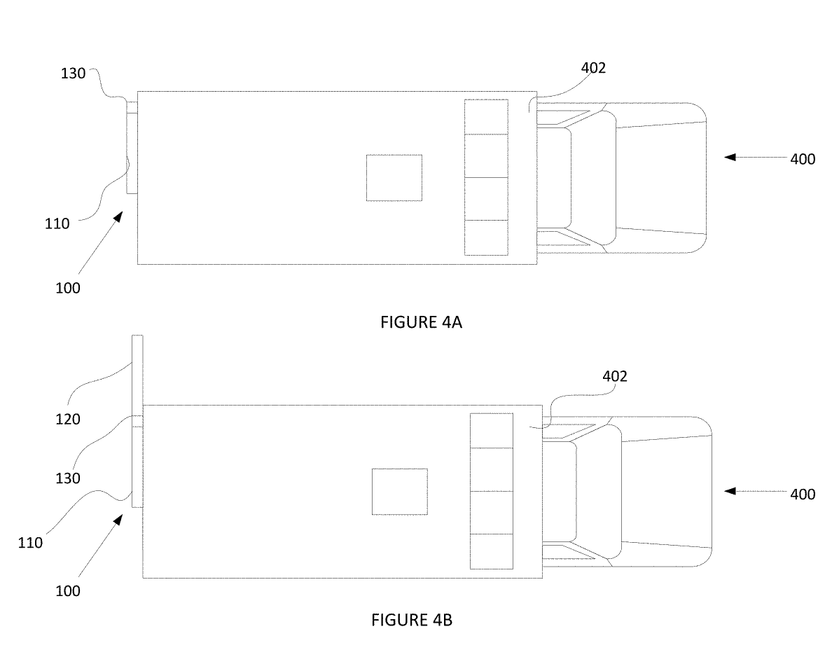

With reference now to FIGS. 4A and 4B, top views 400 of the retractable emergency alert mechanism 100 are shown mounted to an exemplary emergency vehicle 402 as shown respectively in retracted (4A) and deployed (4B) states in accordance with the invention. As described above, deployment mechanism 130 causes second member 120 to rotate or pivot or slide away from first member 110 and vehicle 402 so as to provide a safety zone along the side of the vehicle 402 to guard against approaching traffic adjacent to the vehicle. As described illuminating and messaging displays are provided to alert approaching drivers of the stopped vehicle and the need for caution when driving around the vehicle.

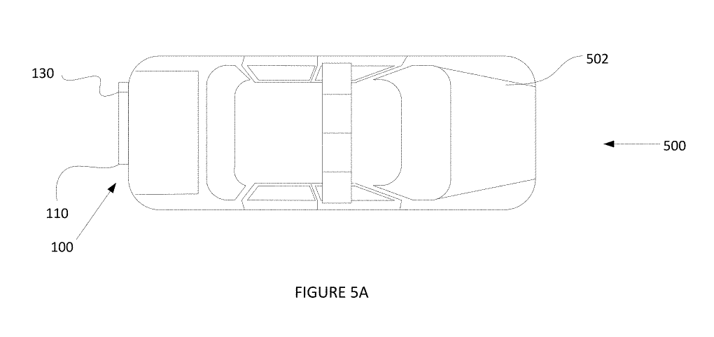

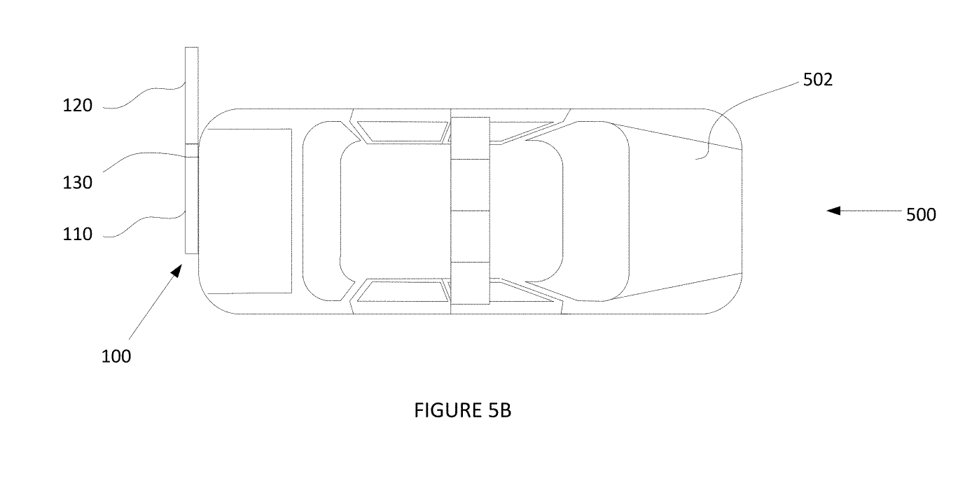

With reference now to FIGS. 5A and 5B, top views 500 show the retractable emergency alert mechanism 100 mounted to an exemplary law enforcement vehicle 502 as shown respectively in retracted (5A) and deployed (5B) states in accordance with the invention. As described above, deployment mechanism 130 causes second member 120 to rotate or pivot or slide away from first member 110 and vehicle 502 so as to provide a safety zone along the side of the vehicle 502 to guard against approaching traffic adjacent to the vehicle. As described illuminating and messaging displays are provided to alert approaching drivers of the stopped vehicle and the need for caution when driving around the vehicle.

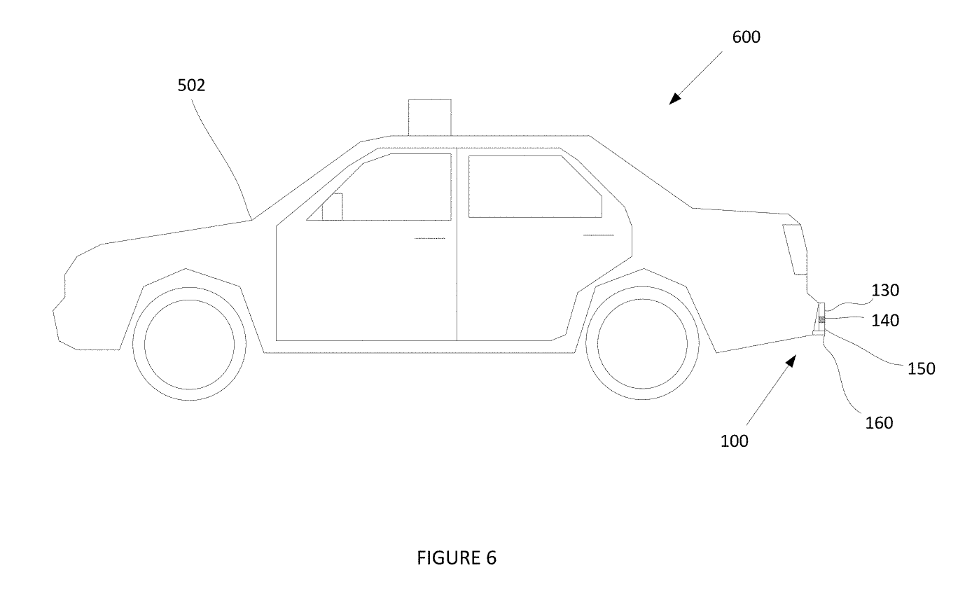

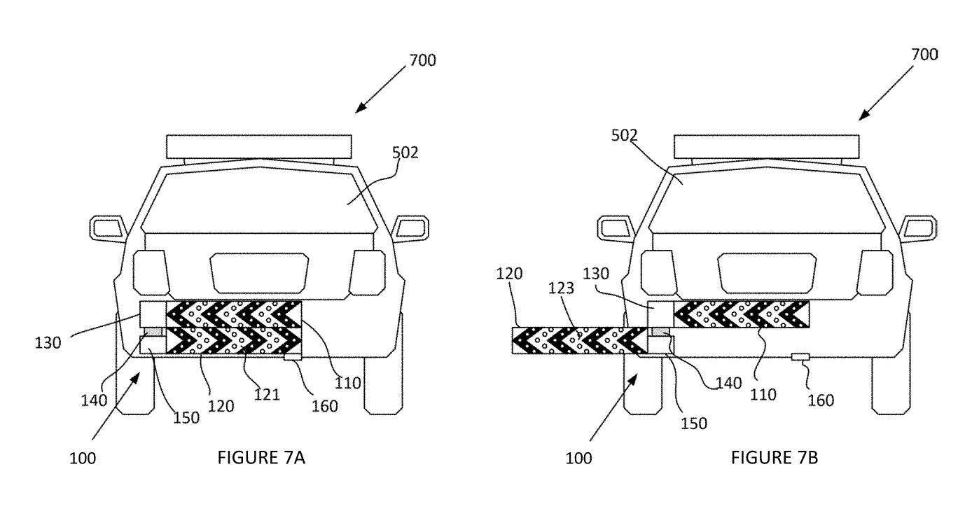

With reference now to FIG. 6, a side view 600 shows the retractable emergency alert mechanism 100 mounted to a rear end of the exemplary law enforcement vehicle 502 of FIGS. 5A and 5B. Also with reference to FIGS. 7A and 7B, rear views 700 show the retractable emergency alert mechanism 100 mounted to a rear end of the exemplary law enforcement vehicle 502 of FIGS. 5A and 5B as shown respectively in retracted (7A) and deployed (7B) states in accordance with the invention. As shown and consistent with the description above, alert mechanism 100 is configured so that in a retracted state second member 120 rests at stop 160 abutting the vehicle 502. Deployment mechanism 130,140,150 cause the second member to rotate or pivot or slide away from vehicle 502 so as to provide a safety zone along the side of the vehicle 502 to guard against approaching traffic adjacent to the vehicle. As described flashing or reflective segments 123 shown in the shape of directional arrows direct approaching traffic away from the vehicle 502 by alerting approaching drivers of the stopped vehicle and the need for caution when driving around the vehicle. Messaging displays or panels may also be provided along with camera and proximity sensors.

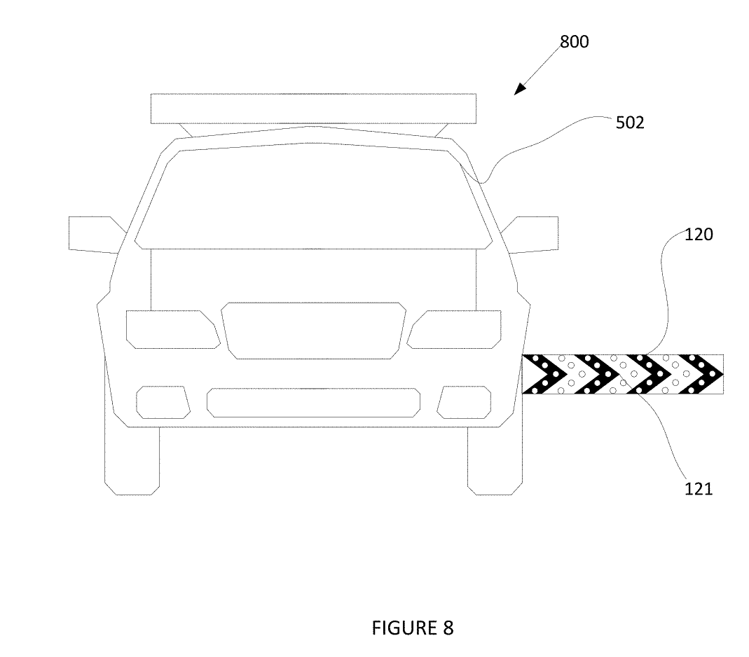

With reference now to FIG. 8, a front view 800 shows the retractable emergency alert mechanism 100 mounted to a rear end of the exemplary law enforcement vehicle 502 and is shown in a deployed state. Reflective arrow-shaped illuminated devices 123 may be provided on the front-facing surface of the second member 120 as well as the rear facing surface depicted and described above.

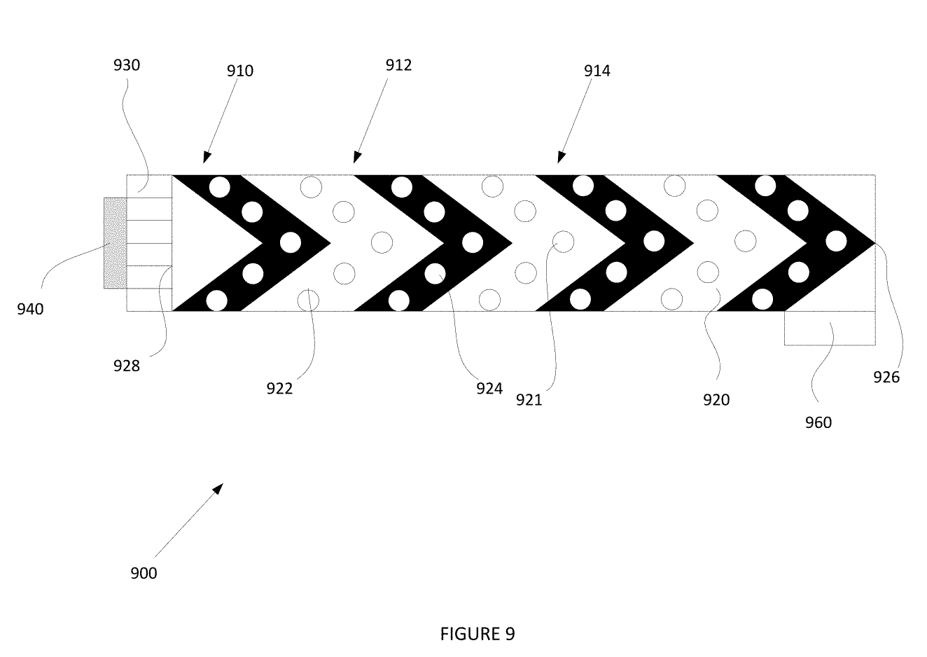

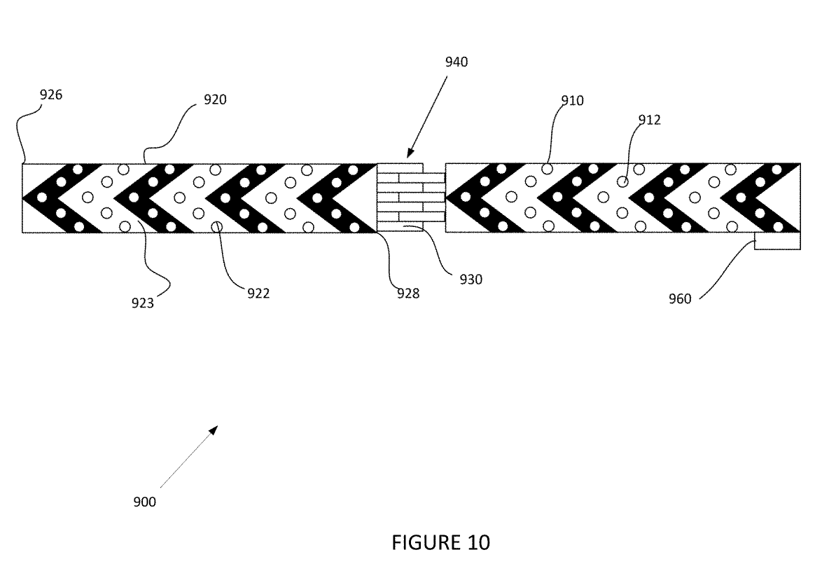

With reference now to FIGS. 9 and 10, schematic diagrams of a further alternative configuration retractable emergency alert mechanism 900 are shown respectively in a retracted state (FIG. 9) and in a deployed state (FIG. 10). In this embodiment second member 920 overlaps with first member 910 when in the retracted position. Deployment mechanism 940 is in the form of a hinge 930. Although preferably the alert mechanism is electromechanically deployed such as by an actuator mechanically linked to the second member or the hinge/deployment mechanism, the second member may be manually deployed and in particular manually deployed in the event the actuator malfunctions. Camera 922 may be included on the rearward facing side of the second member toward approaching traffic to record driving behavior during traffic stops and to record any incident requiring submission of evidence in a civil or criminal proceeding. Flashing LEDs 912 and reflective or illuminated arrows 923 are shown on the rear facing side of both members 910 and 920.

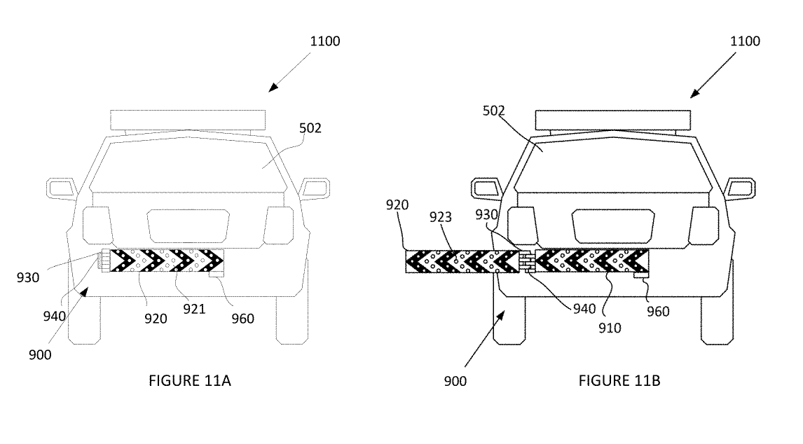

With reference now to FIGS. 11A and 11B, rear views 1100 of the alternative retractable emergency alert mechanism 900 of FIG. 9 is shown mounted to a rear end of an exemplary law enforcement vehicle 502 as shown respectively in retracted (11A) and deployed (11B) states. The operation of alert mechanism 900 is as described above.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A retractable alert mechanism for directing non-responding traffic away from a responding vehicle and personnel, the alert mechanism comprising:
a first member adapted to be fixably attached to a rear portion of a police vehicle;
means for affixing the first member to the rear portion of the police vehicle;
a second elongated member movably attached to the first member;
a deployment mechanism operably connected to the first member and the second elongated member and adapted to permit movement of the second elongated member relative to the first member from a retracted position to a deployed position;
a set of alert indicators affixed to the second elongated member and comprising illuminating elements to give visual indication when the second elongated member is deployed; and
an actuator adapted to electromechanically move the second elongated member from a retracted position to a deployed position and from a deployed position to a retracted position, whereby in a deployed position with the police vehicle stopped along a vehicle roadway the occupant of the vehicle may deploy the second elongated member causing it to extend outwardly away from the police vehicle and automatically illuminate the alert indicators providing illumination in a rearward direction toward approaching traffic to direct traffic away from the police vehicle.

2. The alert mechanism of claim 1 wherein the deployment mechanism comprises a pivot mechanism allowing the second elongated member to pivot outward from the rear of the police vehicle and away from the first member when being actuated from a retracted position to a deployed position.

3. The alert mechanism of claim 1 wherein the deployment mechanism comprises a sliding mechanism allowing the second elongated member to slide outward from the rear of the police vehicle and away from the first member when being actuated from a retracted position to a deployed position.

4. The alert mechanism of claim 1 wherein the deployment mechanism comprises a hinge mechanism allowing the second elongated member to rotate outward from the rear of the police vehicle and away from the first member when being actuated from a retracted position to a deployed position.

5. The alert mechanism of claim 1 further comprising a camera positioned to capture video of approaching traffic when the second elongated member is in the deployed position.

6. The alert mechanism of claim 1 further comprising a proximity sensing device adapted to sense a proximity of an approaching vehicle to the police vehicle and to activate a high intensity alert indicator directed to the approaching vehicle.

7. The alert mechanism of claim 1 further comprising a proximity sensing device adapted to sense a proximity of an approaching vehicle to the police vehicle and to activate an alert indication to the officer operating the police vehicle.

8. The alert mechanism of claim 1 wherein the means for affixing the first member is supported at least in part on a rear bumper of the police vehicle.

9. The alert mechanism of claim 1, wherein the set of alert indicators includes one or more of a light emitting device (“LED”), an illuminated text message, a flashing directional arrow representation, and a series of lights illuminating in a repeating sequence.

10. The alert mechanism of claim 1 wherein the actuator is an electromechanical device electrically controlled by a control device located in the interior of the police vehicle.

11. A retractable alert mechanism for use with a responding vehicle for alerting of emergency situations, the alert mechanism comprising:
an anchor adapted to be fixably attached to a rear portion of an emergency vehicle;
means for affixing the anchor to the rear portion of the emergency vehicle;
an elongated member movably attached to the anchor;
a deployment mechanism operably connected to the anchor and the elongated member and adapted to permit movement of the elongated member relative to the anchor from a retracted position to a deployed position;
a set of alert indicators affixed to the elongated member and comprising illuminating elements to give visual indication when the elongated member is deployed; and
an actuator adapted to electromechanically move the elongated member from a retracted position to a deployed position and from a deployed position to a retracted position, whereby in a deployed position with the emergency vehicle parked and located at the site of an emergency the occupant of the vehicle may deploy the elongated member causing it to extend outwardly away from the emergency vehicle and automatically illuminate the alert indicators providing illumination in a rearward direction from the emergency vehicle.

12. The alert mechanism of claim 11 wherein the deployment mechanism comprises a pivot mechanism allowing the elongated member to pivot outward from the rear of the emergency vehicle and away from the anchor when being actuated from a retracted position to a deployed position.

13. The alert mechanism of claim 11 wherein the deployment mechanism comprises a sliding mechanism allowing the elongated member to slide outward from the rear of the emergency vehicle and away from the anchor when being actuated from a retracted position to a deployed position.

14. The alert mechanism of claim 11 wherein the deployment mechanism comprises a hinge mechanism allowing the elongated member to rotate outward from the rear of the emergency vehicle and away from the anchor when being actuated from a retracted position to a deployed position.

15. The alert mechanism of claim 11 further comprising a camera positioned to capture video of approaching traffic when the elongated member is in the deployed position.

16. The alert mechanism of claim 11 further comprising a proximity sensing device adapted to sense a proximity of an approaching vehicle to the emergency vehicle and to activate a high intensity alert indicator directed to the approaching vehicle.

17. The alert mechanism of claim 11 further comprising a proximity sensing device adapted to sense a proximity of an approaching vehicle to the emergency vehicle and to activate an alert indication to the responder operating the emergency vehicle.

18. The alert mechanism of claim 11 wherein the means for affixing the anchor is supported at least in part on a rear bumper of the emergency vehicle.

19. The alert mechanism of claim 11, wherein the set of alert indicators includes one or more of a light emitting device (“LED”), an illuminated text message, a flashing directional arrow representation, and a series of lights illuminating in a repeating sequence.

20. The alert mechanism of claim 11 wherein the actuator is an electromechanical device electrically controlled by a control device located in the interior of the emergency vehicle.
